(19) United States
(12) Patent Application Publication
(10) Pub. No.: US 2026/0117908 A1
(43) Pub. Date: Apr. 30, 2026

(54) PULSATION DAMPER HAVING A CLAMPING SLEEVE AND METHOD FOR PRODUCING A PULSATION DAMPER HAVING A CLAMPING SLEEVE

(71) Applicant: CONTINENTAL AUTOMOTIVE TECHNOLOGIES GMBH, Hannover (DE)

(72) Inventors: Maximilian KRETSCHMER, Mainhausen (DE); Uwe GREIFF, Seligenstadt (DE); Axel HINZ, Neu-Anspach (DE)

(73) Assignee: CONTINENTAL AUTOMOTIVE TECHNOLOGIES GMBH, Hannover (DE)

(21) Appl. No.: 19/156,464

(22) PCT Filed: Jan. 17, 2024
(86) PCT No.: PCT/DE2024/035003

§ 371 Date: Aug. 14, 2025

(30) Foreign Application Priority Data
Feb. 15, 2023 (DE) 102023201264.2

(51) Int. Cl. F16L 55/054; B60T 8/40

(52) U.S. Cl. CPC F16L 55/054; B60T 8/4068

(57) ABSTRACT

A pulsation damper for damping pressure medium fluctuations in a hydraulic system, in particular in a motor vehicle brake system, including a plug with a sleeve-shaped extension and a hat-shaped elastomeric membrane which is at least partially inserted into the extension of the plug. The membrane includes a collar with an edge-side bead, wherein the collar of the membrane is pushed around an edge of the extension. The bead bears on the outer side against the extension, and the membrane is connected in a pressure-tight manner to the plug via a clamping sleeve acting on the outer side on the bead and on the extension; and a method for producing a pulsation damper.

### CROSS REFERENCE TO RELATED APPLICATIONS

This application is the U.S. National Phase Application of PCT International Application No. PCT/DE2024/035003, filed Jan. 17, 2024, which claims priority to German Patent Application No. 10 2023 201 264.2, filed Feb. 15, 2023, the contents of such applications being incorporated by reference herein.

### FIELD OF THE INVENTION

The invention relates to a pulsation damper according to the preamble of the independent device claim and to a method for producing a pulsation damper according to the preamble of the further independent method claim.

### BACKGROUND OF THE INVENTION

A pulsation damper for damping pressure medium fluctuations in a hydraulic system, in particular a motor vehicle brake system, is known from document DE 10 2021 202 290 A1, incorporated herein by reference, which belongs to the prior art. The pulsation damper is arranged in a bore inside a housing. The pulsation damper comprises a membrane which is inserted into a plug, wherein the plug is inserted into the bore with the membrane in front. The membrane is pushed around an extension of the plug, wherein the end of the membrane is fastened to the outside of the extension of the plug by way of a retaining ring. For this purpose, the membrane is vulcanized onto the retaining ring. By fastening the membrane to the plug via the retaining ring, a gas-tight and liquid-tight unit is formed. This is because the membrane inserted into the extension of the plug delimits, with the latter, a gas space which brings about a damping function. As is known, the membrane is exposed on the side lying opposite the gas space to the pressure fluctuations of a hydraulic fluid. A piston pump generates pressure peaks which occur in a pulse-like manner and which the pulsation damper damps on the path of the hydraulic fluid to a consumer. When a pressure peak occurs, this pressure is dissipated by the elastic membrane which is pressed into the gas space. As a result, a fluid flow with reduced pressure fluctuations flows to the hydraulic consumer.

The tightness of the pulsation damper or the gas space is significant for ensuring the function of the hydraulic system. Due to component tolerances and varying material expansion in the event of temperature changes, a leak can occur between the membrane and the plug. During operation, however, no gas may escape from the gas space and enter the hydraulic system. Entrained gases in the hydraulic fluid can lead to the failure of system-critical components. For this reason, it is important to ensure a permanently pressure-tight connection between the elastomeric membrane and the plug of the pulsation damper.

### SUMMARY OF THE INVENTION

An aspect of the invention is a pulsation damper for damping pressure medium fluctuations, in the case of which pulsation damper the pressure-tight connection between a plug and a membrane is improved, and to provide a method for producing a pulsation damper, which method ensures an improved pressure-tight connection of a plug to a membrane.

The pulsation damper is used in a hydraulic slip-controlled motor vehicle brake system for damping pressure medium fluctuations caused by a piston pump.

### BRIEF DESCRIPTION OF THE DRAWINGS

Preferred embodiments of the invention result from the dependent claims and the following description of one exemplary embodiment with reference to the figures, in which:

FIG. 1 shows a pulsation damper in a housing, and

FIGS. 2A to 2E show method steps for producing a pulsation damper.

### DETAILED DESCRIPTION OF EXEMPLARY EMBODIMENTS

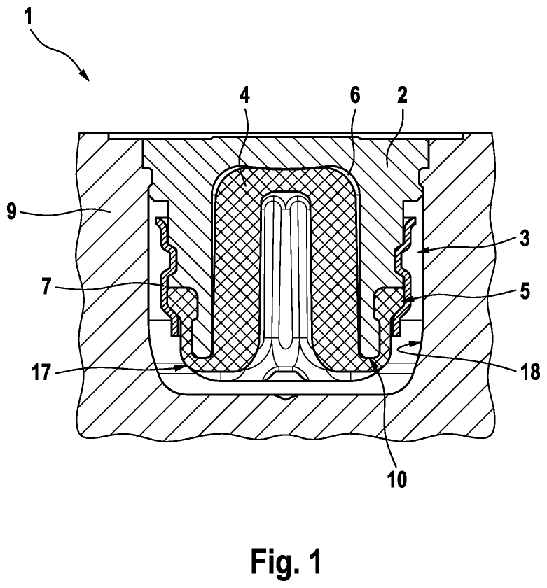

FIG. 1 shows an exemplary pulsation damper 1 which is inserted into a bore 18 of a housing 9. The housing 9 can be, for example, the housing of a piston pump. The bore 18 is exposed to a hydraulic fluid which, for example, comes from the piston pump. The hydraulic fluid provided by the piston pump is under a fluctuating pressure. The pulsation damper 1 is therefore used to dissipate high pressure peaks. The pulsation damper 1 substantially comprises a plug 2 and a membrane 4 made from an elastomeric material. The plug 2 comprises a sleeve-shaped extension 3 protruding from its bottom. The membrane 4 is inserted at least partially into this extension 3. A collar 17 of the membrane 4 is pushed over an edge 10 of the extension 3, wherein a bead 5 which bears on the outer side against the extension 3 of the plug 2 is formed on the edge side of the collar 17.

The membrane 4 which is inserted into the extension 3 delimits, with the plug 2, a damping gas space 6. Thus, the membrane 4 is exposed to a gas on the side facing the plug 2 and to the hydraulic fluid on the side facing away from the plug 2. In order to ensure a pressure-tight connection between the plug 2 and the membrane 4, a clamping sleeve 7 is provided, according to the example. The clamping sleeve 7 presses the bead 5 against the extension 3 from the outside and is also pressed into it itself. For this purpose, the clamping sleeve 7 is manufactured from a metallic material, preferably from steel. The clamping sleeve 7 thus clamps the elastomeric bead 5 at the extension 3 in such a way that a permanently pressure-tight connection is formed between the membrane 4 and the plug 2. As a result, no gas can escape from the gas space 6 into the bore 18 or into the hydraulic fluid. The contour of the clamping sleeve 7 is selected here in such a way that a radial and an axial clamping force act on the bead 5.

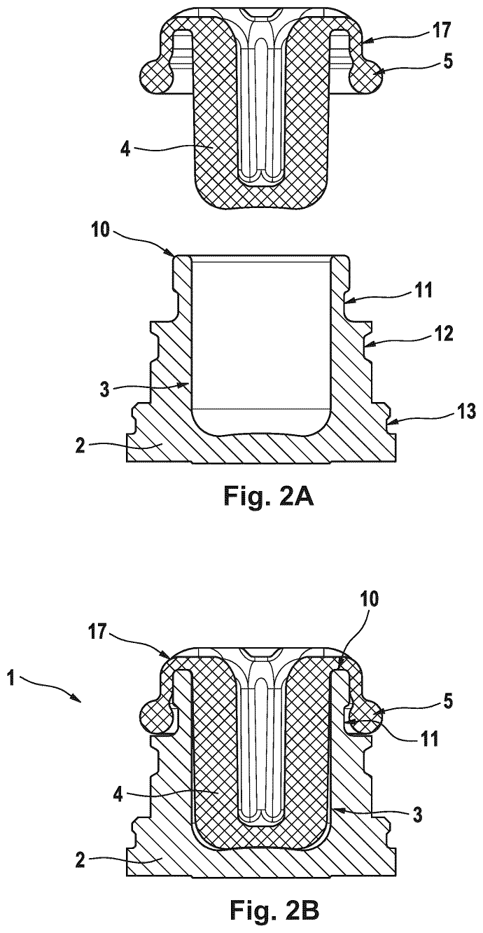

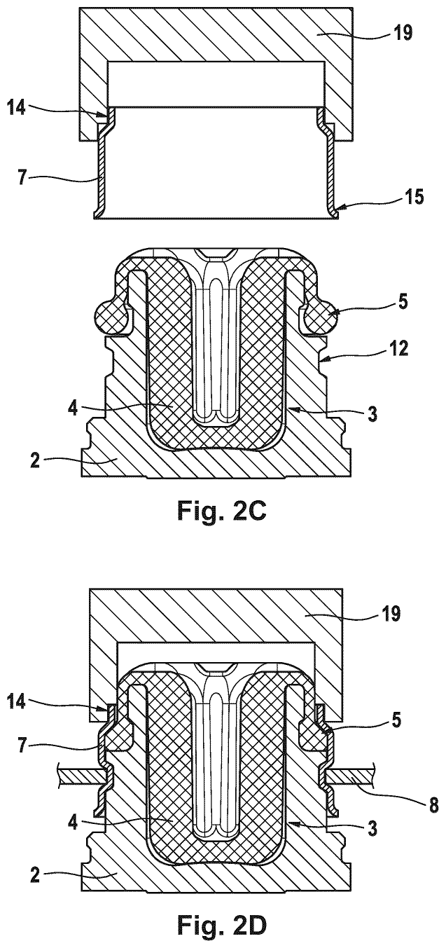

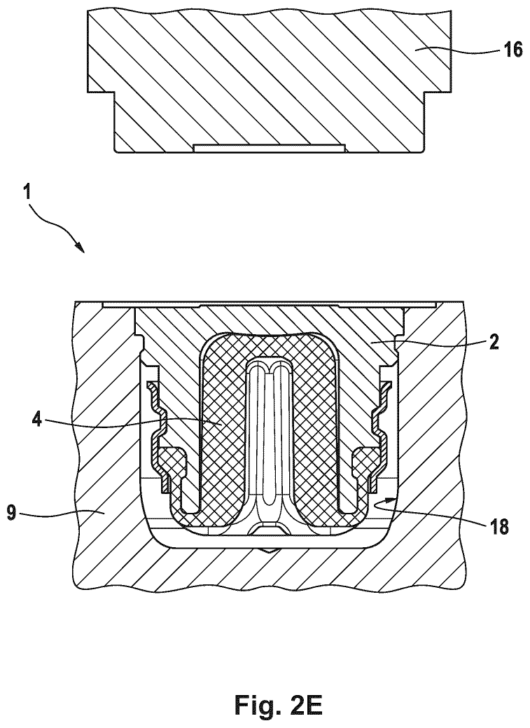

A method according to the example for producing such a pulsation damper 1 is to be explained with reference to FIGS. 2A to 2E. In a first method step according to FIG. 2A, the membrane 4 and the plug 2 are provided. The elastomeric membrane 4 is already vulcanized in its final form. Here, the hat-shaped membrane 4 comprises a hollow-cylindrical wall portion and a bottom, the membrane being inserted with said bottom in front into the extension 3 of the plug 2. The hollow-cylindrical wall portion merges into a collar 17 which is turned over outwardly and forms a bead 5 at its edge. The collar 17 is provided to be placed around the edge 10 of the extension 3. The bead 5 is provided to be pressed on the outer side against the extension 3 in a pressure-tight manner by means of the clamping sleeve. For this purpose, the extension 3 comprises, below the edge 10, a bead groove 11 which runs around on the outer side and into which the bead 5 is inserted. Below the bead groove 11, the extension 3 comprises a clamping groove 12, into which a part region of the clamping sleeve is later pressed. Furthermore, the extension 3 or the plug 2 comprises, on the bottom region, a clinch groove 13 which runs around on the outer side and is provided for pressing the plug 2 with the housing during the course of joining by clinching.

Then, in a next method step according to FIG. 2B, the membrane 4 is inserted into the extension 3 of the plug 2, with the result that its collar 17 is pushed around the edge 10 of the extension 3, and the bead 5 is in contact in the bead groove 11.

In the next method step according to FIG. 2C, the clamping sleeve 7 is provided on a pressing tool 19. The diameter of the clamping sleeve 7 is dimensioned such that it can be pushed over the extension 3 of the plug 2. This means that the internal diameter of the clamping sleeve 7 corresponds substantially to the external diameter of the extension 3. This external diameter is measured below the clamping groove 12. Furthermore, the clamping sleeve 7 comprises, on the upper side, a tapered edge 14 which later rests above the bead 5, in order to bring about a substantially axially acting pressing force on the bead 5 there. In addition, the clamping sleeve 7 comprises, on the underside, a widened edge 15 which enables centered pushing onto the extension 3 of the plug 2.

Then, in the next method step according to FIG. 2D, the clamping sleeve 7 is pushed over the bead 5 and onto the extension 3, with the result that the clamping sleeve 7 comes to lie with its tapered edge 14 on the bead 5. Here, the pressing tool 10 brings about axial pressing of the edge 14 against the bead 5. The tapered edge 14 of the clamping sleeve 7 thus presses the bead 5 into the bead groove provided for this purpose. The conical transition region from the tapered edge 14 to the normal diameter of the clamping sleeve 7 also brings about pressing in of the bead 5, however. The clamping sleeve 7 is subsequently pressed against the extension 3 by way of a clamping tool 8 which acts on the outer side. For this purpose, the clamping tool 8 comprises individual segments which are shifted radially inward. In detail, the clamping tool 8 acts on a defined position of the clamping sleeve 7 in order to press a clamping region of the clamping sleeve 7 into the clamping groove, provided for this purpose, of the extension 3. Due to the resulting radial diameter reduction, the clamping sleeve 7 deforms plastically in the clamping region and thus brings about a radially acting clamping force on the extension 3. As a result, the membrane 4 or its bead 5 is fastened in a pressure-tight manner to the plug 2 or its extension 3. The connection thus produced of the plug 2 to the membrane 4 is considered to be pressure-tight. It is not subject to any component tolerances, and the different material expansion in the event of a temperature change is not a problem.

Finally, in a further method step according to FIG. 2E, the pulsation damper 1, which is assembled according to the example, is inserted into the bore 18 of the housing 9. By means of a clinching tool 16, the plug 2 is deformed by means of joining by clinching to the bore 18 and is thus connected to the housing 9 in a firm and likewise pressure-tight manner.

### LIST OF DESIGNATIONS

1 Pulsation damper
2 Plug
3 Extension
4 Membrane
5 Bead
6 Gas space
7 Clamping sleeve
8 Clamping tool
9 Housing
10 Edge
11 Bead groove
12 Clamping groove
13 Clinch groove
14 Tapered edge
15 Widened edge
16 Clinching tool
17 Collar
18 Bore
19 Pressing tool

1. A pulsation damper for damping pressure medium fluctuations in a hydraulic system, in particular in a motor vehicle brake system, comprising a plug with a sleeve-shaped extension and a hat-shaped elastomeric membrane which is at least partially inserted into the extension of the plug, wherein the membrane comprises a collar with an edge-side bead wherein the collar of the membrane is pushed around an edge of the extension, whereby the bead bears on the outer side against the extension, wherein the membrane is connected in a pressure-tight manner to the plug via a clamping sleeve acting on the outer side on the bead and on the extension.

2. The pulsation damper as claimed in claim 1, in the extension of the plug comprises a bead groove which runs around on the outer side and in which the bead of the membrane bears.

3. The pulsation damper as claimed in claim 1, wherein the extension of the plug comprises a clamping groove which runs around on the outer side and into which a clamping region of the clamping sleeve is pressed.

4. The pulsation damper as claimed in claim 1, wherein the clamping sleeve comprises a tapered edge which brings about an axial clamping force on the bead.

5. The pulsation damper as claimed in claim 1, wherein the clamping sleeve comprises a widened edge, by which the clamping sleeve is plugged over the extension.

6. A method for producing a pulsation damper, comprising:
providing a plug with an extension,
providing a membrane made from an elastomeric material with a folded-over bead,
inserting the membrane into the extension of the plug, wherein the bead bears on the outer side against the extension,
providing a clamping sleeve and pushing the clamping sleeve axially over the extension, and
axially pressing the clamping sleeve with a pressing tool, with the result that a part of the clamping sleeve is pressed axially against the bead, and
radially pressing the clamping sleeve with a clamping tool, with the result that a clamping region of the clamping sleeve is pressed against the extension.

7. The method as claimed in claim 6, wherein the bead is pressed by a tapered edge of the clamping sleeve into a bead groove of the

8. The method as claimed in claim claim 6, wherein the clamping region of the clamping sleeve is pressed into a clamping groove of the extension.

9. The method as claimed in claim 6, wherein the membrane is first vulcanized into a hat-shaped shape with a collar turned inside out with an edge-side bead.

10. The method as claimed in claim 6, wherein the clamping sleeve is produced by deep drawing in advance of said method steps.

11. The pulsation damper as claimed in claim 2, wherein the extension of the plug comprises a clamping groove which runs around on the outer side and into which a clamping region of the clamping sleeve is pressed.

12. The method as claimed in claim 7, wherein the clamping region of the clamping sleeve is pressed into a clamping groove of the extension.
